(19) United States
(12) Patent Application Publication
(10) Pub. No.: US 2006/0268582 A1
(43) Pub. Date: Nov. 30, 2006

(54) Medical lamp assembly having liquid tight seal

(76) Inventor: John Charles Scoins, Rancho Palos Verdes, CA (US)

Correspondence Address: Curtis L. Harrington, Suite 250, 6300 State University Drive, Long Beach, CA, 90815, US

(21) Appl. No.: 11/141,841

(22) Filed: May 31, 2005

(51) Int. Cl. H01R 33/00

(52) U.S. Cl. 362/645; 362/158; 362/267

(57) ABSTRACT

A subminiature lamp assembly utilizes a high temperature polymer which directly surrounds and is cemented to the glass envelope. The polymer may preferably derive support from a metal base. The polymeric material is somewhat rigid and can be manually handled and used to manipulate the subminiature lamp as a handle to facilitate bulb changout. A fluoroelastomer is a preferable type of elastomer which has the chemically resistive properties and ability to withstand high temperature which can be advantageously employed. The elastomer used for the seal supported lamp assembly provides (1) extended axial length sealing, (2) heat resistance, (3) ease of handling, (4) increased resistance to invasion and chemical attack (5) eliminates contact corrosion, and (6) reduces lamp failure modes.

### FIELD OF THE INVENTION

The present invention relates to the field of high intensity, thermal, efficient incandescent lamps, subminiature lamps, lamp assemblies, and a lamp system and method of making an efficient high intensity bulb and sleeve system having a liquid tight seal.

### BACKGROUND OF THE INVENTION

Small incandescent lamps, especially subminiature lamps, have a glass envelope which has traditionally been supported by a one or two piece base. The base typically has a low pitch thread for providing mechanical fixation to a socket, as well as for providing a conductor for one conductor of a two conductor subminiature lamp element. In most subminiature lamps of this type conduction for the other conductor is provided through a peg conductor centered in an insulator carried at the bottom-most part of the lower base.

The upper glass envelope has to be supported. Normally a metal sleeve is employed which fixes movement of the conducting leads, aligns the envelope with respect to the sleeve, and permanently supports the glass envelope throughout its life. Current practices for holding a subminiature lamp in a metal housing employs a ceramic adhesive between the glass envelope and the inside of a metal support sleeve.

The use of an adhesive to support the glass envelope within a metal sleeve has a number of problems. First, this adhesive eventually breaks down from repetitive use of the subminiature lamp due to the thermal cycling between the high temperature of the lamp's operating temperature and its return to room temperature. The subminiature lamp temperature can be as high as 300° C.

Secondly, the use of any material to bond a glass envelope having a low thermal expansion characteristic to what is typically a metal sleeve having a much higher thermal expansion coefficient will cause a destructive shear each time the subminiature lamp is thermally cycled. This shearing movement, combined with other factors hastens the degradation of the adhesive material used within a subminiature lamp.

Third, and particularly where the subminiature lamp is exposed to an environment where it needs to be cleaned or sterilized, such as a contaminated medical environment, liquid cleaning procedures can degrade the adhesive. Where the subminiature lamp is used for examinations or operations, a high cyclical rate of cleaning occurs over the life of the subminiature lamp.

Fourth, moisture migrates through the fracture cracks of the adhesive into the interior of the subminiature lamp. The moisture causes the electrical contacts to corrode which causes early subminiature lamp failures. The combination of the above four factors works together to cause conventional subminiature lamps to fail at an unacceptably high rate.

One configuration proposed to combat the aforementioned problems includes the use an internal 0-ring in place of the adhesive to try to prevent liquid from migrating into the subminiature lamp internals, but this has proven unworkable as the manufacture and placement of a thin o-ring is extremely difficult and problematic. A housing external 0-ring can provide a seal between subminiature lamp metal housing and the socket, but only helps prevent liquid from entering the subminiature lamp interior from the socket end.

Another problem with conventional subminiature lamps is the high amount of heat which is conducted from the glass envelope. Much of the heat immediately makes its way into the metal housing. In appliances where the subminiature lamp is mounted near the outside of the appliance, burns can result from touching the metal sleeve. Even where a heat insulatory sleeve is mounted peripherally outwardly of the metal base or metal housing, burns can still occur if the end of the housing is inadvertently touched.

What is needed is a solution which will provide a much longer bulb life by combating the above mechanisms of bulb degradation. The solution should also help provide further protection from burns for users, regardless of the type of appliance in which the bulb is used.

### SUMMARY OF THE INVENTION

The subminiature lamp assembly of the present invention utilizes a high temperature polymer which directly surrounds and is in compression contact with the glass envelope. The polymer may preferably derive support from a metal base. The polymeric material is somewhat rigid/molded and can be manually handled and used to manipulate the subminiature lamp. A fluoroelastomer is a preferable type of elastomer which has the chemically resistive properties and ability to withstand high temperature which can be advantageously employed. The elastomer used for the seal supported lamp assembly provides (1) extended axial length sealing, (2) heat resistance, (3) ease of handling, and (4) increased resistance to invasion and chemical attack.

### BRIEF DESCRIPTION OF THE DRAWINGS

These and other aspects of the invention will be better understood from the following description in which reference is made to several drawings of which:

FIG. 1 is a side cross sectional view of a prior art incandescent subminiature lamp and base with an optional peripheral thermal insulative coating, axially compressed “o” ring, and shown in a subminiature lamp socket;

FIG. 2 is a side cross sectional view of a prior art incandescent subminiature lamp and base with an optional peripheral thermal insulative coating, and a radially compressed “o” ring, and shown in a subminiature lamp socket;

FIG. 3 is a side cross sectional view of a first embodiment of the invention with the polymeric supporting cover fitted over the subminiature lamp glass envelope and over at least a portion of the subminiature lamp base;

FIG. 4 is a configuration in the same general orientation as seen in FIG. 3 but with a potting material such as pourable silicone directly under the glass envelope and helping to stabilize the electrical leads; and

FIG. 5 is a side cross sectional view showing the subminiature lamp of FIG. 4 mounted in a socket having a dimension such that a lower directed radial face of the molded sleeve opposes an upper directed radial face of the socket.

### DETAILED DESCRIPTION OF THE PREFERRED EMBODIMENT

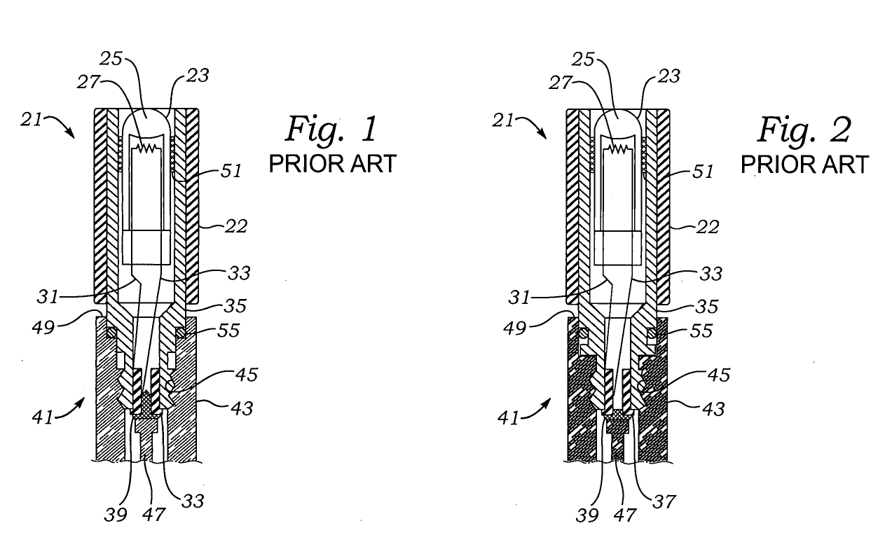

The prior art will first be illustrated to show the subminiature lamp environment conventionally in use. Referring to FIG. 1, a conventional subminiature lamp assembly 21 is seen. An optical envelope assembly is seen as having an outer glass envelope 23 which may have an optional thickened lens portion 25 near a filament 27 to either focus or disperse the light leaving the filament. A pair of electrical leads extend down, both below and out of the boundary of the glass envelope 23 and through what is shown as a one piece conductive base 35. Lead 31 is pressed against the inner surface of the base 35 by an insulative plug 37. Lead 33 is typically pressed against the outer surface of a conductive plug 39 by the inside of the insulative plug 37. A first type of conventional socket 41 includes a conductive outer portion 43 which includes an inner threaded portion 45. Socket 41 has a center conductor 47. Socket 41 may also have an upper radial surface 49 opposed to a polymeric supporting cover 22 which covers the one piece conductive base 35 completely. In this case, the polymeric supporting cover 22 is simply applied to a continuous metal surface. Lateral heat flow is slowed, but the open end of the one piece conductive base 35 remains exposed and can burn users even more readily than inadvertent contact with the outer glass envelope 23.

A thin layer of cement or adhesive 51 is used predominantly to fix the axial position of the envelope 23 within the upper portion of the one piece conductive base 35. The tolerance between the envelope 23 and the inner cylindrical wall of the upper portion one piece conductive base 35 is small enough to promote control of the thin layer of cement or adhesive 51. Repeated washing and sterilization begin to degrade and erode the thin layer of cement or adhesive 51 from the front end of the conventional subminiature lamp assembly 21, where contaminants are then able to reach the leads 31 and 33.

The other path for entry, from the outside between the socket 41 and engaged one piece conductive base 35, is guarded by an “o” ring 55. It should be kept in mind that path guarded by the “o” ring 55 is more tortuous and less likely to “infect” the conventional subminiature lamp assembly 21, because any contaminants must continue downward, not be lost in the area between the center conductor 47 and conductive outer portion 43, and then navigate the very tight spaces between the inside of the one piece conductive base 35, the insulative plug 37, and the conductive plug 39. As such, the “o” ring 55 is largely to protect the inside of the socket 41. In addition, the “o” ring 55 is shown in a configuration to be compressed axially.

Referring to FIG. 2, a view of the prior art conventional subminiature lamp assembly 21 as seen in FIG. 1 is shown, but with a socket 53 which accommodates an “o” ring 55 for lateral compression. One piece conductive base 35 carries a stop structure 57 engaged by a complementary structure of the socket 53. In this configuration, the “o” ring 55 is radially compressed by the side wall of the one piece conductive base 35 against the inside of the socket 41.

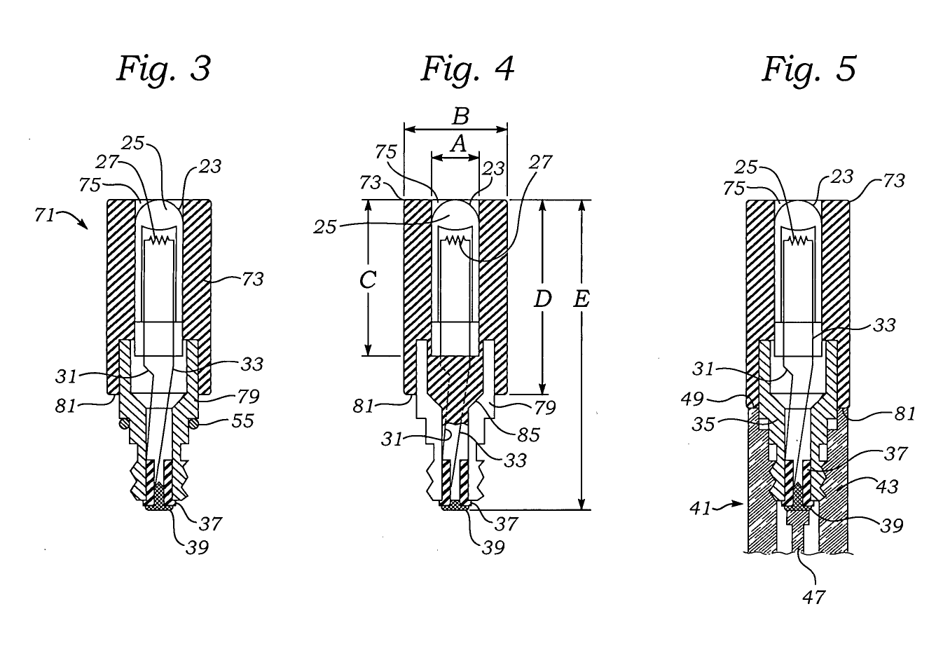

Referring to FIG. 3, an isolated view of a seal supported subminiature lamp assembly 71 is seen outside of the socket 41 environment. A polymeric seal support 73 is seen as having a bore 75 which tightly forms a seal around the glass envelope 23. The polymeric seal support 73 also extends downward into contact with the upward face 77 of an abbreviated height one piece conductive base 79. The polymeric seal support 73 also extends downward and over the exterior of the abbreviated height one piece conductive base 79. The length to which the abbreviated height one piece conductive base 79 extends may depend on the support needs of the glass envelope 23 and may also depend upon the height to which a socket 41 rises about the abbreviated height one piece conductive base 79. In some cases, as will be shown, an axially bottom face 81 can be used to seal against a matching face on a socket 41 if one exists.

The material used for the polymeric seal support 73 should be non thermally conducting and able to withstand significant subminiature lamp temperature. One material which has been shown to work well is a material sold under the trademark VITON® and is a fluoroelastomer commercially available from DuPont Dow Elastomers. It is known for its excellent (400° F./200° C.) heat resistance, as well as offering excellent resistance to aggressive fuels and chemicals. It is available with a variety of mechanical properties. The material can be pre-selected to resist permeation and volume increase, resist attack and property degradation caused by chemicals and fluids. The range of degradation resistance includes resistance to amines or caustics, resistance to hydrocarbon fluids such as are used in sterilization, and controlled flexibility at low temperature which translates into the ability to maintain a seal at a range of temperatures from low temperature to high temperature. The seal is maintained during the subminiature lamp assembly 71 operation, is maintained during heat sterilization, and its integrity continues to remain during the introduction of low temperature sterilizing liquids.

In terms of the shape of the polymeric seal support 73 seen in FIG. 3, the material is available as a solid cylindrical rope which can be bored out to accommodate the glass envelope 23, as well as to custom fit any type of abbreviated height one piece conductive base 79. The part may also be a molded component. Any shape of fit between the abbreviated height one piece conductive base 79 and the polymeric seal support 73 which promotes structural cooperation, support and efective bonding is encouraged. For example, the upward face 77 can be shaped to complementarily fit a matching internal surface of the polymeric seal support by the use of any complementary matching structures, including but not limited to teeth, the provision of an extended annular space containing an annular extent of the polymeric seal support 73 between the glass envelope 23 and an extended internal surface of the abbreviated height one piece conductive base 79. Fingers projecting upwardly from the abbreviated height one piece conductive base 79 can also be used. The fingers can be either complementary to the internal shape of the polymeric seal support 73 or may be thinner and pierce the material of the polymeric seal support 73 without disrupting the seal between the cylindrical periphery of the glass envelope 23 and the matching cylindrical inside of the polymeric seal support 73.

The construction of the seal supported subminiature lamp assembly 71 can include keyed spacing and placement of the envelope 23 and abbreviated one piece conductive base 79 into a matching space within the polymeric seal support. Any material can be used between the glass envelope and abbreviated height one piece conductive base 79 to fix them for the time and force required to fit the polymeric seal support 73.

As seen in FIG. 3 is the polymeric seal support 73 forms a housing around both the glass envelope 23 and the abbreviated height one piece conductive base 79. The polymeric seal support 73 now encapsulates the glass envelope 23 making a liquid tight seal. Where it is preferable, the polymeric seal support 73 material may be chosen based upon the maximum working temperature of the elastomer. Fluorocarbon has a maximum temperature of 200° C. and silicone has a maximum temperature of 232° C. These materials must withstand the operating temperature of the subminiature lamp bulb or glass envelope wall, especially the point nearest the filament. This hottest point will have a temperature which may vary with different subminiature lamp wattage ratings. These types of elastomer materials are also selected because they are chemically non reactive. Further, because they are polymeric, the possibility exists to include additives where it is important to achieve other objectives. The simplest might include, color for instance, where the material additive makes quick selection of the seal supported subminiature lamp assembly 71 of paramount importance. Color can also affect the electromagnetic absorbance of the material.

Another possibility is to either use a combination of materials for the polymeric seal support 73. For example, the polymeric seal support 73 may have a much more dense material in its lower half to better support the glass envelope 23 with respect to the abbreviated height one piece conductive base 79, and a less dense upper half of material to provide additional insulation. In this event, the lower sealing would be more important. A more complete seal, however will likely depend upon the length of axial touching of the polymeric seal support 73 against the length of the glass envelope 23, and without a break in the material used for the polymeric seal support 73.

Referring to FIG. 4, an added feature is shown along with dimension lines useful in illustrating the dimensions of the seal supported subminiature lamp assembly 71. Underneath the glass envelope 23, a volume of potting material 85, which may be pourable or non-pourable, and may be added with appropriate spacing of the glass envelope 23 with respect to the abbreviated height one piece conductive base 79 to fix it stably. The potting material may include silicone, epoxy or any other stable, temperature resistant material. Also, the addition of such potting material 85 will also better protect the upper portions of the leads 31 and 33. The potting material 85 should be sufficient to withstand any axial compression of the glass envelope 23 against the abbreviated height one piece conductive base 79 as the polymeric seal support 73 is being fitted. The external surface of the glass envelope 23 and the internal surface of the polymeric seal support 73 should not have the presence of any material which might promote wicking.

To give one possible set of dimensions of a subminiature lamp with which the inventive method and materials may be practiced, FIG. 4 includes a set of letter designations associated with the dimension lines shown. A typical seal supported subminiature lamp assembly 71 might include a glass envelope having a diameter “A” of approximately 0.176 inches and fitted with a polymeric seal support 73 having bore 75 of approximately 0.171 inches in diameter which will stretch to fit around the glass envelope and assume an internal diameter of 0.176 as it applies force along the axial surface of glass envelope 23.

The overall exterior diameter of the polymeric seal support 73 may have a diameter “B” of approximately 0.35 inches. The overall height of the glass envelope 23 may be a dimension “C” of approximately 0.550 inches. The overall height of the polymeric seal support 73 is a dimension “D” of about 0.73 inches. The overall height of the seal supported subminiature lamp assembly 71 is a dimension “E” of about 1.085 inches. The thickness of the polymeric seal support 73 lying just outside of and covering the abbreviated height one piece conductive base 79 may have a radial thickness of about 0.37 inches.

Referring to FIG. 5, a view of the seal supported subminiature lamp assembly 71 mounted within a socket 41 illustrates the possibility that the axial bottom face 81 of the polymeric seal support 73 can meet and press against the upper radial surface 49 of the socket 41. This mechanism can provide additional sealing and also supply additional friction to help keep the seal supported subminiature lamp assembly 71 from turning out of its threaded socket 41.

In terms of theory of operation, the polymeric seal support 73 makes a static radial seal (seal on inside of the polymeric seal support 73) with the straight sidewall of the subminiature lamp glass envelope 23 surface. The actual polymeric seal support 73 seal length (subminiature lamp glass envelope 23 cylindrical surface to polymeric seal support 73) is now much longer than conventional “o” ring type seals.

Internal O-ring seals have a resulting seal length, glass to o-ring, in the vicinity of 0.027 inches, assuming an o-ring width of 0.032 inches. Polymeric seal support 73 seals are accordingly longer lengths because the elastomer now is in contact with approximately the whole straight portion of glass of the glass envelope 23, which can be about 0.350 inches long in accord with the dimensions discussed for FIG. 4. By calculation, 0.350/0.027 represents a ratio of thirteen times longer length seal at the desired compression level. Stretch levels and compression level are recommended by the industry to range between 1 and 5% of the resting stretch and compression to limit accelerated aging and elastomer decomposition. In this case the bulb OD is specified at 0.176 inches and the ID of the polymeric seal support 73 is specified at 0.171 inches. The stretch level thus can be computed as (0.176/0.171)−1=0.0292≈3%.

The second advantage of the seal supported lamp assembly 71 over conventional lamps with adhesive or cement is the elimination of either adhesive or cement. Adhesive is usually applied to the ID of the base and a conventional subminiature lamp is inserted to a designed reference point within the base. Normally this reference point is the tip of the subminiature lamp envelope. Metal housings are machined to allow a clearance of about 0.003 inches with respect to the glass portion of the conventional subminiature lamp to allow for the volume of the adhesive. As a result, the application of the adhesive is normally uneven around the internal diameter of the metal housing. That is, one side may get more adhesive than the other requiring more distance/volume between subminiature lamp and metal housing on one side.

This creates an off center condition for the conventional subminiature lamp to the central axis of the base. The polymeric seal support 73 has the inherit quality to allow much closer tolerance centering of the subminiature lamp glass envelope 23 to the axis of the abbreviated height one piece conductive base 79 because there is no adhesive. The stretch ratio given, and its close equivalents are sufficient to hold the subminiature lamp in place.

Further, the leads 31 and 33 as shown have an interference fit, at the abbreviated height one piece conductive base 79 and the insulative plug 37, as well as between the insulative plug 37 and the conductive plug 39. These interference fits create tiny open passageways around each side of the leads 31 and 33. Therefore the internal seal supported subminiature lamp assembly 71 internal space below the glass envelope 23 has a gas composition is equal and shared by the instrument internal gas volume (best represented by the space between the center conductor 47 and conductive outer portion 43 seen in FIG. 5). Assembly of the subminiature lamps generally to an instrument consists of inserting the threaded end of the subminiature lamp into the instrument orifice and turning the subminiature lamp. The threads engage and draw the subminiature lamp into the instrument until the subminiature lamp base hits either a fixed stop 57, or conversely the “o” ring 55 is available to be compressed. The human hand exerts torque to compress this type of “o” ring seal 55. A seal is made on two sides of the “o” ring seal 55, top and bottom, and is called a static facial or axial seal. Tolerance problems involving three connected parts result in poor seals.

An example of a conventional poor stretch seal of a conventional “o” ring seal around an outer diameter part at 0.208 with an inner diameter “o” ring seal at 0.207 gives (0.208/0.207)−1=0.0048≈0.48% resulting in a poor seal. The compression seal associated with an “o” ring OD at 0.288″ and the instrument “compressed bead” internal diameter at 0.270″ calculates to be (0.288/0.270)−1=7%. A severe imbalance with the seal length much diminished from what was required. The weakest link here would be a 0.48% stretch level “o” ring to a base outer diameter creating a poor stretch seal.

Conventional “o” ring seals traditionally require 2 points to make a seal. The stretch seal around a conventional subminiature lamp housing and the compression seal with the instrument can create a stretch level and compression level which should be in the 1-5% range.

Thus, the next advantage of using a polymeric seal support 73 seal is that again only one surface is required to make a seal. The bottom surface of the molded polymeric seal support 73 is actually a sealing surface, axially bottom face 81 in facial contact with upper radial surface 49. Compression values are directly related to turning forces used to insert the subminiature lamp into the instrument. This area's operating temperature is 75% less in operating temperature than the area near the filament 27. Thus degradation of the material of the seal between the axially bottom face 81 and upper radial surface 49 is significantly reduced with increased excessive compression forces. No “o” ring 55 is required inside the instrument, but it may be used. Dead spaces or passageways that lead to the “o” ring are eliminated from collecting debris.

The current objective is to fabricate a lamp, and in particular a medical subminiature lamp as a seal supported lamp assembly 71 assembly having a liquid tight seal. The above descriptions detail many forms of seals, which possibly would inhibit liquid from entering the interior of the seal supported subminiature lamp assembly 71 and its instrument as represented by the socket 41. Entry of deleterious fluide can corrode contact points, lead 31 connection to metal housing 35, lead 33 to plug 39, plug 39 to contact 47, and metal housing 35 to socket thread 45.

The above physical structures represent the potential for an early failure mechanism. As described, they are static conditions. In actuality, a subminiature lamp is cycled on and off. Air, internal to any subminiature lamp and instrument, is trapped and is building in pressure during the length of an examination when the lamp is lit. Since the internal volume of subminiature lamp/instrument is constant, under conditions of heating the increasing pressure releases itself through the shortest seal length/compression level. This escape of air can occur at the subminiature lamp end or the instrument end. Conversely, when the subminiature lamp is depowered and cools down, ambient atmospheric pressure reverses the flow forcing air through the lowest seal compression level/seal length into the subminiature lamp/instrument cavity. This air can be significantly laden with water vapor, chemicals, and human excretions that are potentially harmful to conventional elastomers and leads 31 and 33 and contact points. Conventional elastomers used tend not to be compatible with steam at temperatures around 177° C. Any internal volumes including those in the lamp housing and instrument, that have “inhaled” water vapor on preceeding light ups and will start expiring water vapor through o-ring seals at the hot end of the of any lamp assembly. The hot end may exceed 177° C., and thus elastomer degradation may be increased. The goal is to minimize the number of sealing points and maximize the length of a seal surface.

Another objective is seen in FIG. 4, where air volume is minimized by backfilling the cavity within the abbreviated height one piece conductive base 79 a pourable potting material 85, preferably silicone. This potting material 85 would solidify and form a barrier for gasses to penetrate into the hot subminiature lamp end.

In terms of assembly, a polymeric seal support 73 with close tolerances is used. An abbreviated height one piece conductive base 79, which may preferably have a hub outer diameter (at the point where it lies underneath the polymeric seal support 73) of about 0.005 inches larger than the mating section of the internal bore of the polymeric seal support 73, may be partially coated with an instant adhesive capable of bonding elastomers to metal. This area is separated significantly from the high temperature portion of the glass envelope 23 adjacent the filament 27.

During assembly, the abbreviated height one piece conductive base 79 may be inserted into the bottom end of the polymeric seal support 73 with the subminiature lamp wires exiting the internal diameter of the abbreviated height one piece conductive base 79 through the opening which would accept the insulative plug 37. A potting material 85 may be injected into the space within the abbreviated height one piece conductive base 79 through it lower opening, or into the opening in the insulative plug 37 if lead 31 is secured first. The remaining wire is pressed against the center opening of the insulative plug 37 by insertion of the conductive plug 39. This last procedure yields the second electrical connection.

The focus of the aforementioned description has been on medical subminiature lamps, but the procedures, structures, materials and techniques can be applied to any situation where insulation, high heat degradation resistance, solvent and chemical resistance is to be derived along with positive effective sealing.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A seal supported lamp assembly comprising:
a conductive base;
an optical envelope assembly;
a polymeric seal support engaging said conductive base and said optical envelope assembly and providing stability for said optical envelope assembly with respect to said conductive base.

2. A seal supported lamp assembly as recited in claim 1 wherein said optical envelope assembly further comprises an envelope having a pair of leads.

3. A seal supported lamp assembly as recited in claim 1 wherein said polymeric seal support includes a bore which surrounds and seals with respect to said optical envelope assembly utilizing an inside surface of said bore.

4. A seal supported lamp assembly as recited in claim 3 wherein said polymeric seal support has a sufficient radial thickness and extends sufficiently downward to form a seal with a socket into which said seal supported lamp conductive base operably engagably fits.

5. A seal supported lamp assembly as recited in claim 3 wherein said polymeric seal support bore also surrounds at least a portion of said conductive base.

6. A seal supported lamp assembly as recited in claim 5 wherein said polymeric seal support has a sufficient radial thickness and extends sufficiently down said conductive base sufficiently to form a seal with a socket into which said seal supported lamp conductive base operably engagably fits.

7. A seal supported lamp assembly as recited in claim 1 wherein said conductive base includes a potting material for supporting said optical envelope assembly at least for installation of said polymeric seal support.

8. A seal supported lamp assembly as recited in claim 7 wherein said potting material reduces an internal volume within said conductive base.

9. A seal supported lamp assembly as recited in claim 3 wherein said optical envelope assembly further comprises an envelope having a pair of leads and wherein said leads extend through said potting material.

10. A seal supported lamp assembly as recited in claim 3 wherein said optical envelope assembly further comprises an envelope having a filament, and wherein said polymeric seal support has a first end farthest from said conductive base and a second end closest said conductive base and wherein said filament is located more closely adjacent said first end of said polymeric seal support than said second end of said polymeric seal support.

11. A seal supported lamp assembly as recited in claim 1 wherein said conductive base has a first end and a second threaded end, and wherein said first end is sealed by a combination of said optical envelope assembly and said polymeric seal support.

12. A seal supported lamp assembly as recited in claim 11 wherein said second end of said conductive base is closed by a combination of an insulative plug and a conductive plug.

13. A seal supported lamp assembly as recited in claim 1 wherein said optical envelope assembly has a first end and a second end; and wherein said polymeric seal support has a first end about even with said first end of said optical envelope assembly, and a second end extending beyond said second end of said optical envelope assembly.

14. A seal supported lamp assembly as recited in claim 1 wherein said optical envelope assembly extends at least partially into said conductive base.
